(19) United States
(12) Patent Application Publication
(10) Pub. No.: US 2003/0116313 A1
(43) Pub. Date: Jun. 26, 2003

(54) Cooling system for electric vehicle

(76) Inventor: Dennis W. O'Donnell, Pittsburgh, PA (US)

Correspondence Address: JAMES RAY & ASSOCIATES, 2640 PITCAIRN ROAD, MONROEVILLE, PA, 15146, US

(21) Appl. No.: 10/280,275

(22) Filed: Oct. 25, 2002

Related U.S. Application Data
(63) Continuation-in-part of application No. 09/788,796, filed on Feb. 19, 2001, now abandoned.

(51) Int. Cl. F28F 1/00; H02K 1/32; H02K 3/24; H02K 5/18; H02K 5/20; H02K 9/00; B60K 1/00; F28D 15/00; B60H 1/00; B60H 1/32

(52) U.S. Cl. 165/202; 165/41; 165/104.21; 62/244; 180/65.1; 310/64

(57) ABSTRACT

A motive power system for an electric vehicle has a drive train connected to one or more drive wheels of the vehicle. The motive power system has an electrical motor having a motive power output connection for attachment to the drive train. A first heat exchanger has thermal connection to the electrical motor to remove heat from the electrical motor, the first heat exchanger employing a coolant fluid. A second heat exchanger is in thermal contact with the coolant fluid and with an ambient atmosphere for removing heat from the coolant fluid.

### CROSS-REFERENCE TO RELATED APPLICATIONS

This application is a continuation-in-part of co-pending patent application Ser. No. 09/788,796 filed Feb. 19, 2001.

### FIELD OF THE INVENTION

The present invention relates to cooling systems for electric vehicles.

### BACKGROUND OF THE INVENTION

The increasing cost of fossil fuels has caused considerable interest in electric vehicles. These include battery powered vehicles, solar cell powered vehicles, and fuel cell powered vehicles. All such vehicles include one or more electric motors connected to drive wheels of the vehicles.

Although electric motors generally have high efficiencies, heat generation does occur. Heat generation occurs due to conduction losses in the coils, hysteresis losses in the magnetic materials, as well as skin effect losses and eddy current losses in the coils and magnetic materials. Some heat is also generated by friction in the bearings and in brushes, if they are present.

Prior art electric vehicles have generally been cooled by air, a circumstance which tends to limit the torque and power which can be obtained from the motors, and which permits temperature rise with an attendant loss of efficiency.

### SUMMARY OF THE INVENTION

In one aspect, the present invention is a motive power system for an electric vehicle having a drive train connected to one or more drive wheels of the vehicle. The motive power system has an electrical motor having a motive power output connection for attachment to the drive train. A first heat exchanger has thermal connection to the electrical motor to remove heat from the electrical motor, the first heat exchanger employing a coolant fluid. A second heat exchanger is in thermal contact with the coolant fluid and with an ambient atmosphere for removing heat from the coolant fluid.

In another aspect, the invention is an electric vehicle having a motive power system which includes an electric motor having a motive power connection to one or more drive wheels of the vehicle. A first heat exchanger has thermal connection to the electrical motor to remove heat from the electrical motor, the first heat exchanger employing a coolant fluid. A second heat exchanger is also in thermal contact with the coolant fluid and with an ambient atmosphere so as to remove heat from the coolant fluid.

### OBJECTS OF THE INVENTION

It is therefore one of the primary objects of the present invention to cool an electrical motor in an electric vehicle.

Another object of the present invention is to reduce copper losses in the windings of an electric motor in an electric vehicle.

Still another object of the present invention is to operate an electric motor in an electric vehicle at a reduced temperature to improve the effectiveness of magnetic materials in the motor.

Yet another object of the present invention is to cool an electric motor in an electric vehicle so that the motor may be operated at an increased power density.

A further object of the present invention is to reduce the weight of one or more electric motors in an electric vehicle.

It is an additional object of the present invention to provide an embodiment of a motive power system for an electric vehicle in which the electric motor is refrigerated.

Still yet another object of the present invention is to provide an electric vehicle having a refrigeration system which cools a motor of the vehicle and also provides air conditioning for passengers.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is a schematic front view of a vehicle having a motive power system according to the present invention.

FIG. 2 is a schematic sectional view cut along the line 2-2 in FIG. 1.

FIG. 3 is a typical phase diagram of a coolant fluid.

FIG. 4 is a schematic illustration of a cooling system for an electric propulsion motor which employs a pair of fluid flow passages for conveying cooling fluid to and from a heat exchanger.

FIG. 5 is a schematic illustration of a cooling system including a fluid pump for conveying cooling fluid to a heat exchanger.

FIG. 6 is a schematic illustration of a cooling system which includes a compressor and an expansion valve to provide refrigeration of a motor in an electric vehicle.

FIG. 7 is a schematic illustration of a system having a capillary expansion valve for refrigerating a motor in an electric vehicle.

FIG. 8 is a schematic illustration of a system having a controllable expansion valve for refrigerating a motor in an electric vehicle.

FIG. 9 is a schematic illustration of a motor cooled by a heat exchanger in contact with the casing of the motor.

FIG. 10 is a schematic illustration of a motor having cooling coils in contact with stator windings of the motor.

FIG. 11 is a schematic illustration of a motor which is cooled by refrigerated air from a heat exchanger.

FIG. 12 is a schematic illustration of a cooling system for an electric vehicle which cools the motor and also provides air conditioning for the vehicle.

FIG. 13 is schematic illustration of an alternative cooling system which cools the motor and also provides air conditioning for the vehicle.

FIG. 14 is a schematic illustration of a cooling system having parallel flow through a heat exchanger for the motor and an air conditioning heat exchanger.

### BRIEF DESCRIPTION OF THE PRESENTLY PREFERRED AND VARIOUS ALTERNATIVE EMBODIMENTS OF THE INVENTION

Prior to proceeding to the much more detailed description of the present invention, it should be noted that identical components which have identical functions have been identified with identical reference numerals throughout the several views illustrated in the drawing figures for the sake of clarity and understanding of the invention.

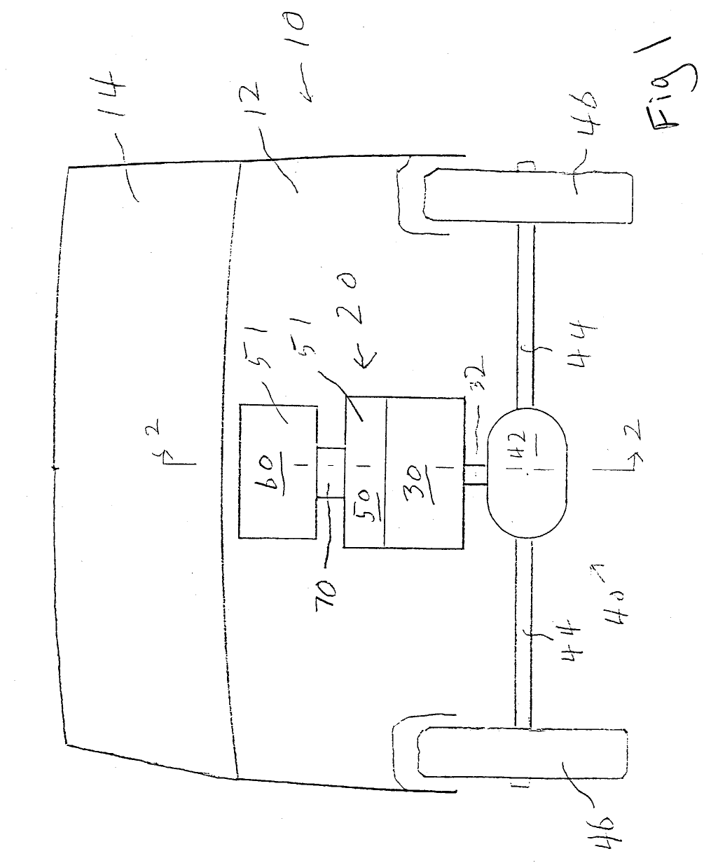

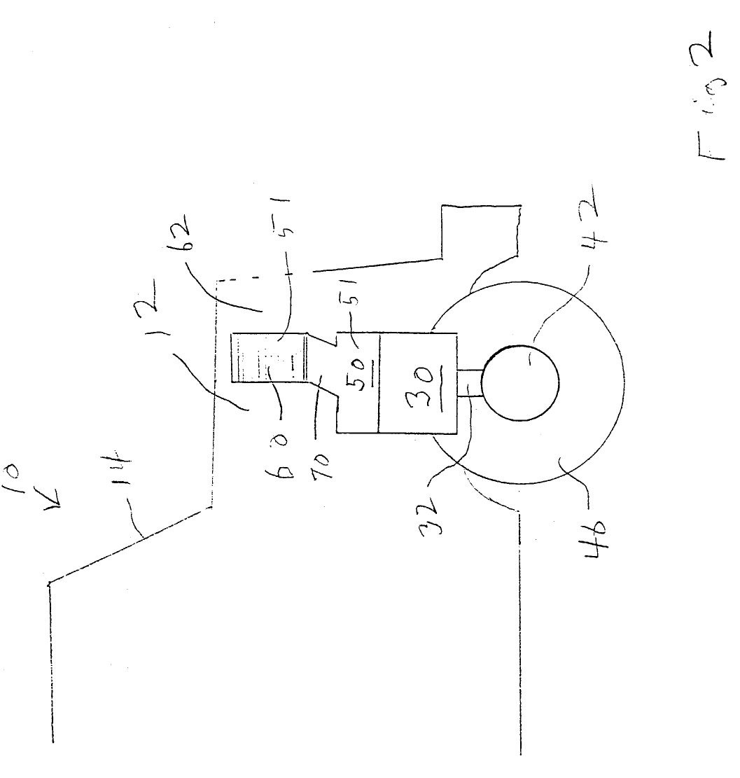

Attention is now directed to FIGS. 1 and 2 which illustrate a motor vehicle, generally designated 10, having an engine compartment 12 and windshield 14. Motor vehicle 10 includes a motive power system, generally designated 20, that includes an electric motor, generally designated 30. Electric motor 30 has a motive power output connection 32 which is for connection to a drive train, generally designated 40, that includes transmission 42 and axles 44, which, in turn, are connected to drive wheels 46. A first heat exchanger, generally designated 50, is in thermal contact with motor 30 for cooling motor 30. First heat exchanger 50 employs a coolant fluid 51 that is also in thermal contact with a second heat exchanger, generally designated 60. Second heat exchanger 60 is cooled by ambient atmosphere 62.

Preferably, a first fluid flow passage, generally designated 70, connects first heat exchanger 50 to second heat exchanger 60 to permit convection of coolant fluid 51.

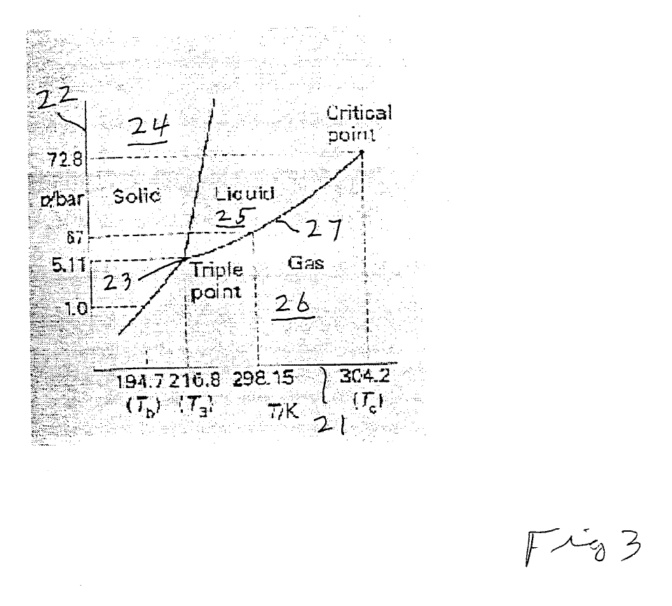

Preferably, coolant fluid 51 cools motor 30 by evaporation or boiling. It is preferred that coolant fluid 51 have a triple point temperature below about minus 40 degrees Celsius. Coolant fluid 51 may be an alcohol at a pressure below one bar absolute. Lowering the absolute pressure of the alcohol lowers its boiling point to provide improved cooling of motor 30. Coolant fluid 51 may also have a pressure greater than one bar absolute. Carbon dioxide, for example, may be employed as a coolant fluid. FIG. 3 illustrates the phase diagram of carbon dioxide. Absolute temperature is indicated on the horizontal axis 21 and absolute pressure is indicated on the vertical axis 22. The triple point 23 where the solid phase 24, liquid phase 25 and vapor phase 26 coexist is at a pressure of 5.11 bar (511,000 Pascals) which is approximately five atmospheres absolute. The temperature at the triple point is 216.8 degrees Kelvin, which is −56.2 degrees Celsius. Preferably, heat transfer occurs across the boundary 27 between liquid 25 and vapor phases 26, so that heat is absorbed as the latent heat of vaporization.

Phase diagrams for alcohols such as methanol and ethanol are generally similar to the phase diagram for carbon dioxide shown in FIG. 3, except that the pressures are lowered.

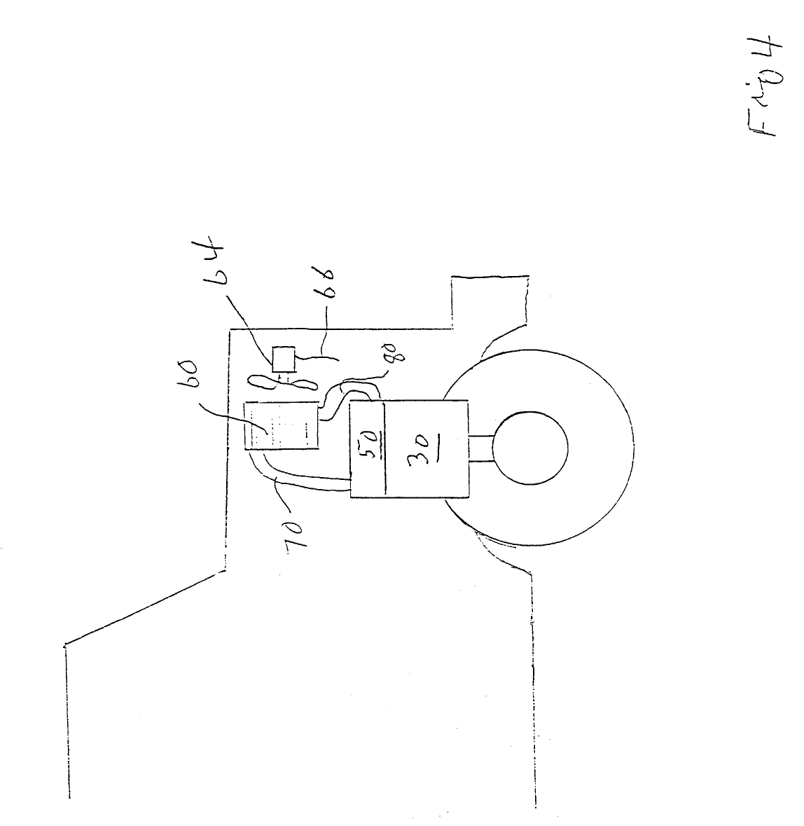

FIG. 4 illustrates a second fluid flow passage, generally designated 80, connecting second heat exchanger 60 to first heat exchanger 50. In this configuration, gravity convection causes coolant fluid 51 to flow through first passage 70 in direction 71 from first heat exchanger 50 to second heat exchanger 60 and to return through second fluid flow passage 80 in direction 81 from second heat exchanger 60 to first heat exchanger 50. Preferably, a fan 64 having control connection 66 is included to improve cooling of second heat exchanger 60. Boiling of fluid 51 increases convection and heat transfer between first heat exchanger 50 and second heat exchanger 60.

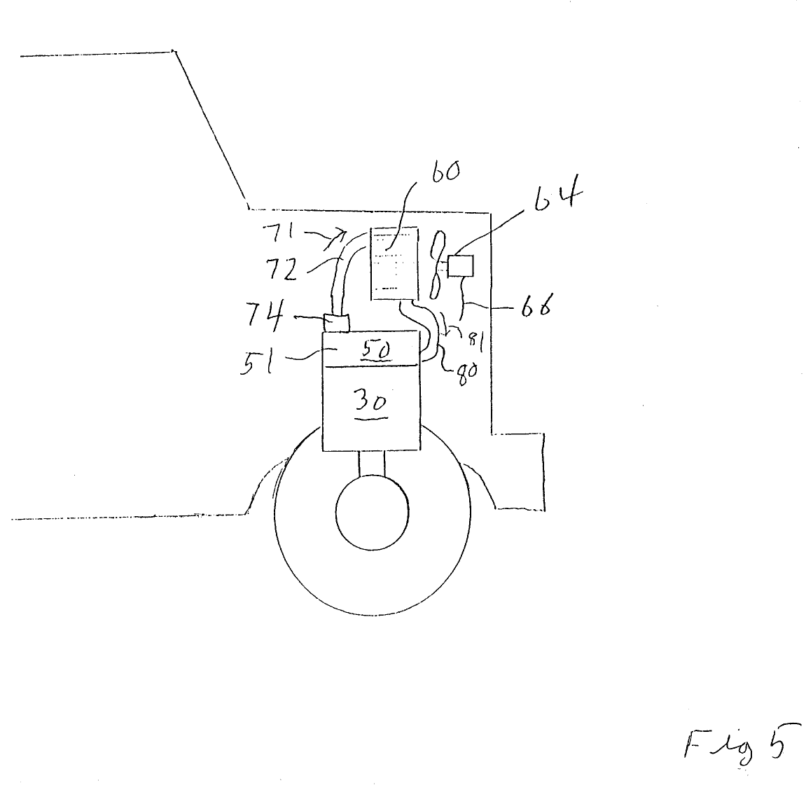

The configuration shown in FIG. 5 includes first fluid flow passage 72 having a pump 74 to enhance convection of coolant fluid 51 from first heat exchanger 50 to second heat exchanger 60 and to return from second heat exchanger 60 to first heat exchanger 50 through second fluid flow passage 80.

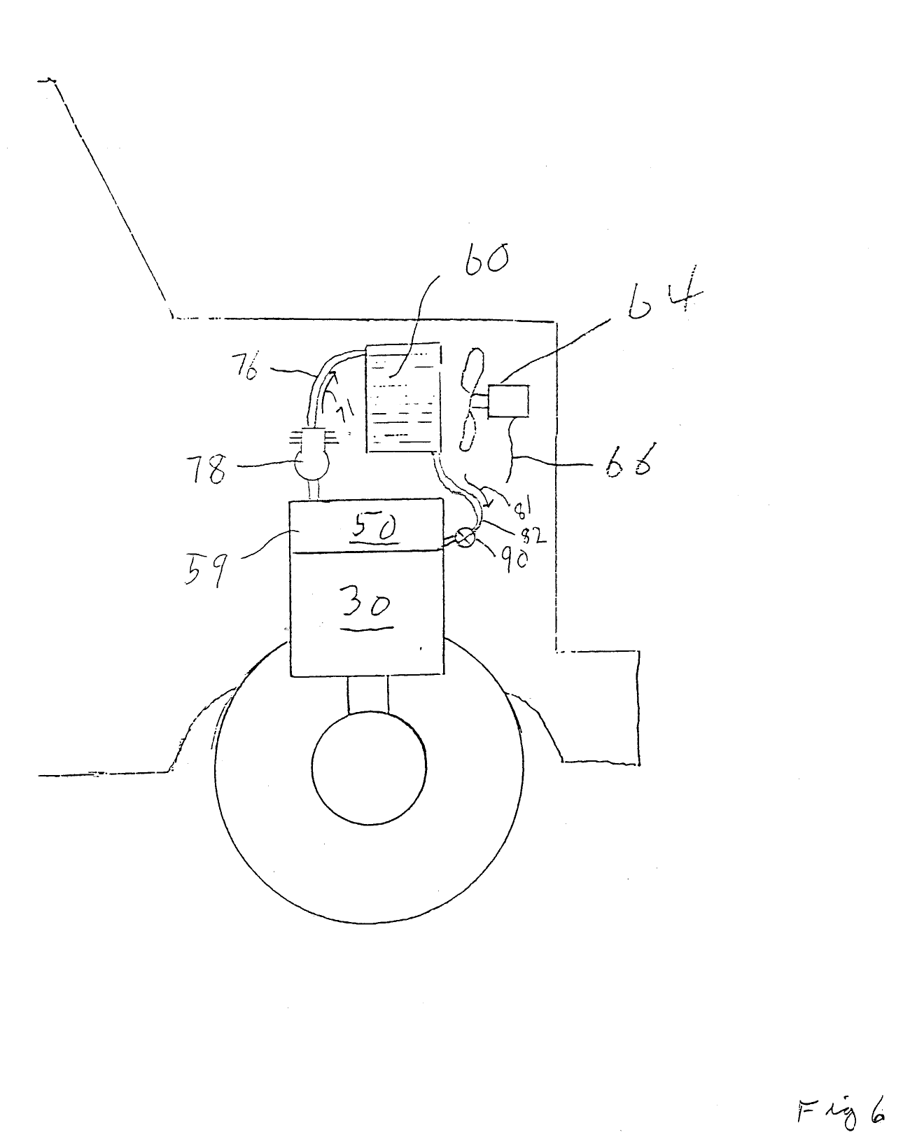

FIG. 6 illustrates a configuration having a first fluid flow passage 76 having a compressor unit 78 and also having a second fluid flow passage 82 having an expansion valve, generally designated 90. Compressor unit 78 includes an electric motor that operates on alternating current. Such electric motor is disposed with in the compressor unit 78 and is used to drive the compressor. With this arrangement, coolant fluid 59 is a refrigeration fluid, preferably R 410A. R407, which matches R22 and R134A are alternatives. With this arrangement, first heat exchanger 50 and motor 30 may be cooled to temperatures below that of the ambient atmosphere, thereby lowering copper losses in motor 30 and improving magnetic materials in motor 30. Preferably, thermal insulation (not shown) is applied to motor 30.

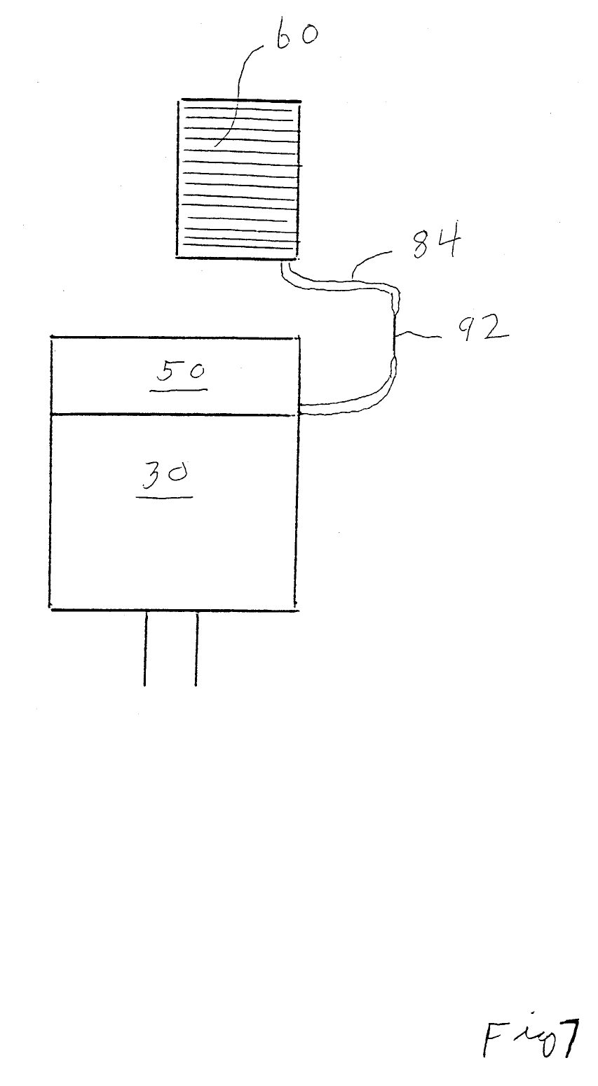

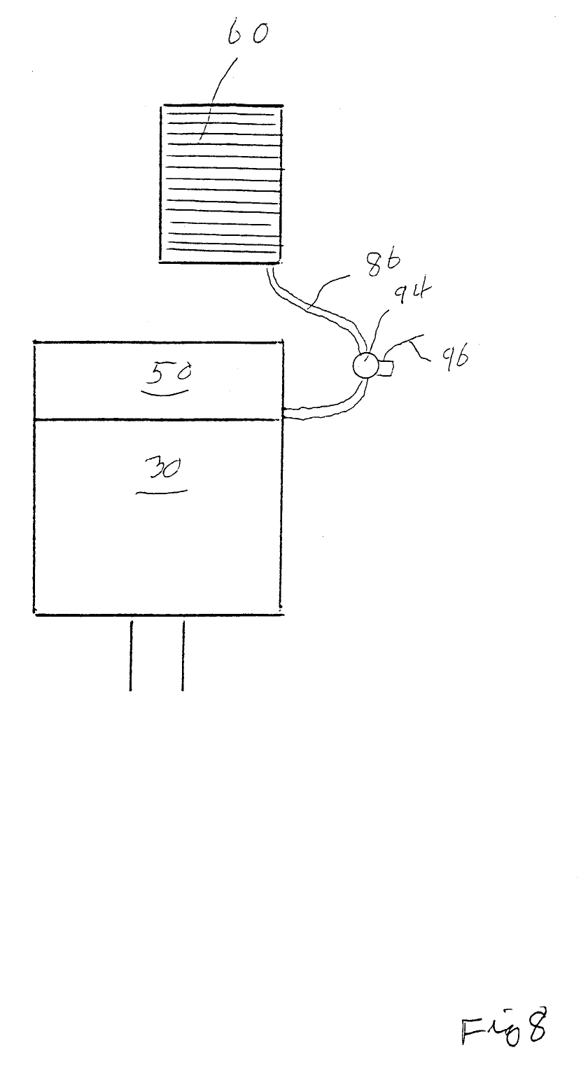

FIG. 7 illustrates an alternative second flow path 84 wherein expansion valve 90 is a capillary 92. FIG. 8 illustrates a preferred second flow path 86 wherein expansion valve 90 is a controllable expansion valve 94, which may be opened and closed by voltages applied to control connection 96.

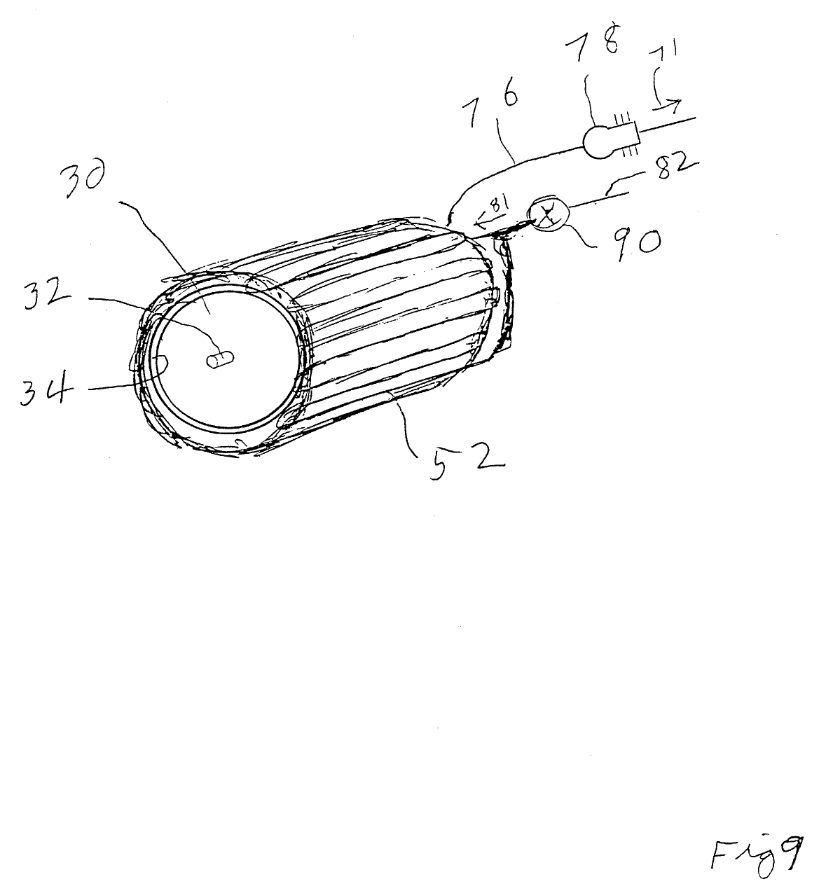

FIG. 9 illustrates an embodiment wherein first heat exchanger 50 is a coil 52 in contact with a casing 34 of motor 30. In this configuration, first fluid flow passage 76 has a compressor unit 78 causing flow in direction 71. The second fluid flow passage 82 has an expansion valve 90 so that motor 30 may be cooled below the temperature of the ambient atmosphere.

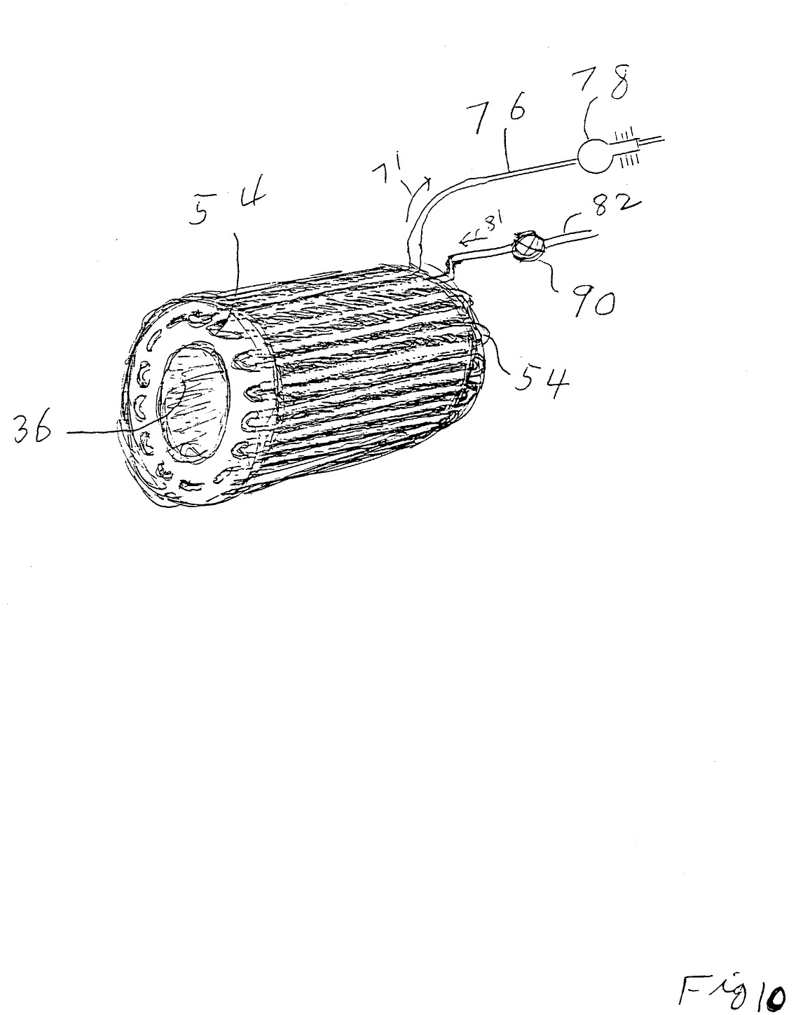

In the embodiment illustrated in FIG. 10, the first heat exchanger 50 is a coil 54 in thermal contact with stator windings 36 of motor 30.

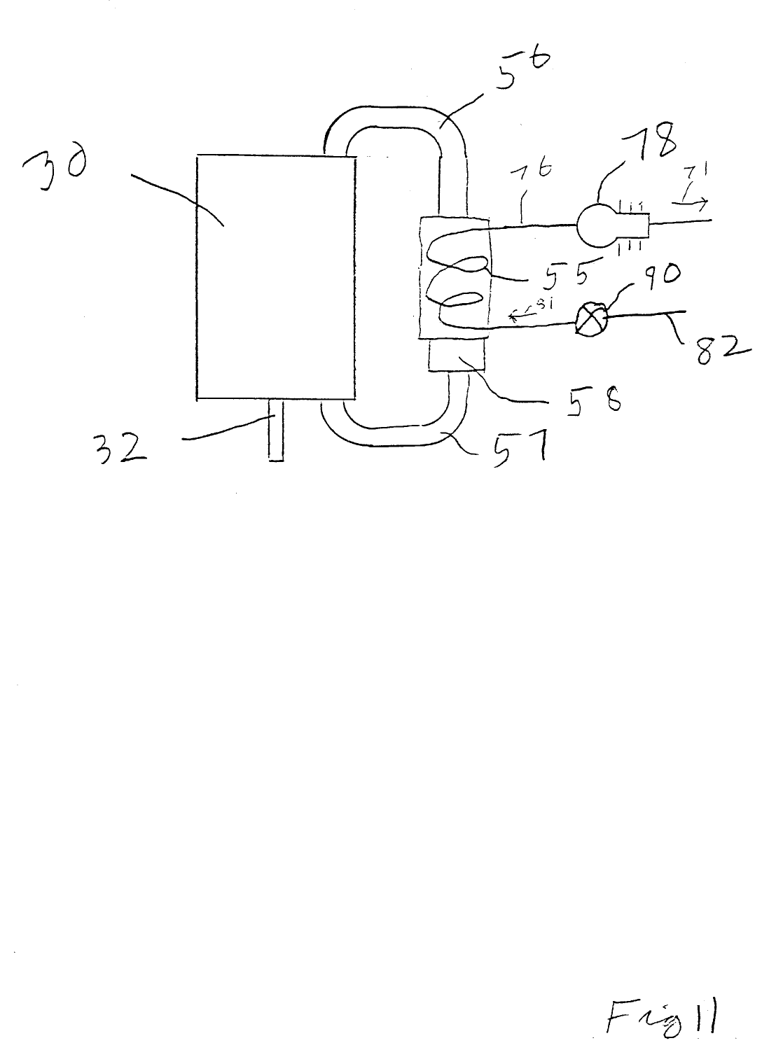

FIG. 11 illustrates the presently preferred embodiment, in which first heat exchanger 50 is a coil 55 which cools air in duct 56 which conveys air to motor 30. A blower 58 in return duct 57 causes air to circulate from coil 55 through motor 30. This configuration is preferred inasmuch as heat is removed from the rotor (not shown), as well as the stator winding 36.

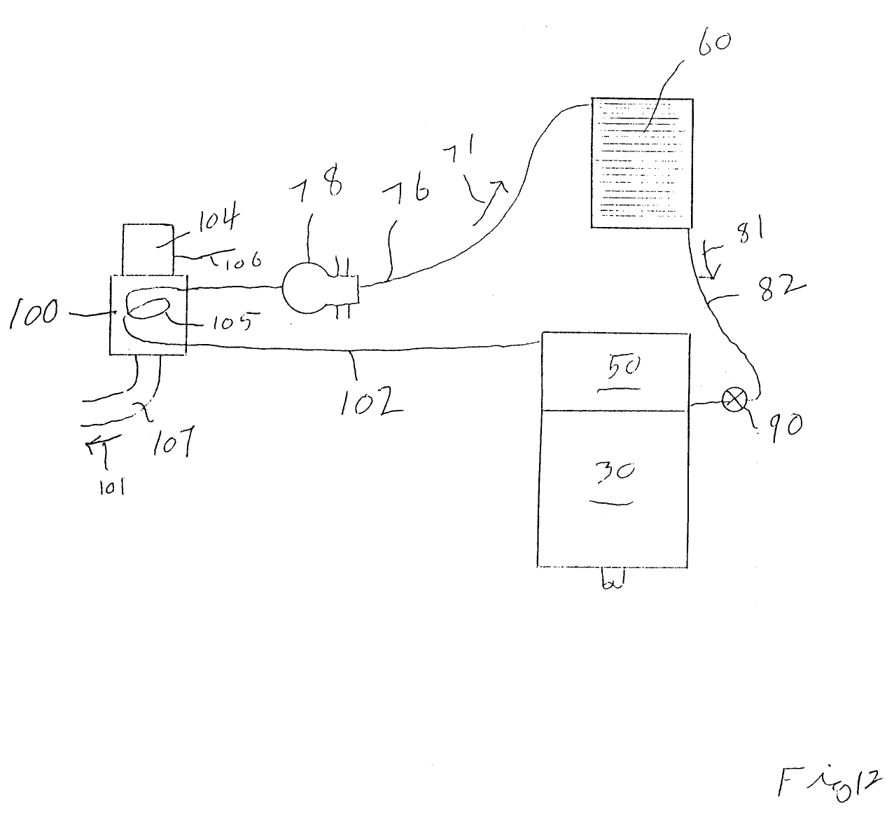

FIGS. 12, 13 and 14 illustrate embodiments which further include a third heat exchanger, generally designated 100, which includes a refrigerated coil 105, a blower 104 and a duct 107 to convey cooled air in flow direction 101 to a passenger compartment (not shown) of electric vehicle 10. Blower 104 has control connection 106.

In the embodiment illustrated in FIG. 12, coolant fluid from expansion valve 90 passes first through first heat exchanger 50 and then through passage 102 to third heat exchanger 100 and thence through first passage 76 including compressor unit 78 to second heat exchanger 60.

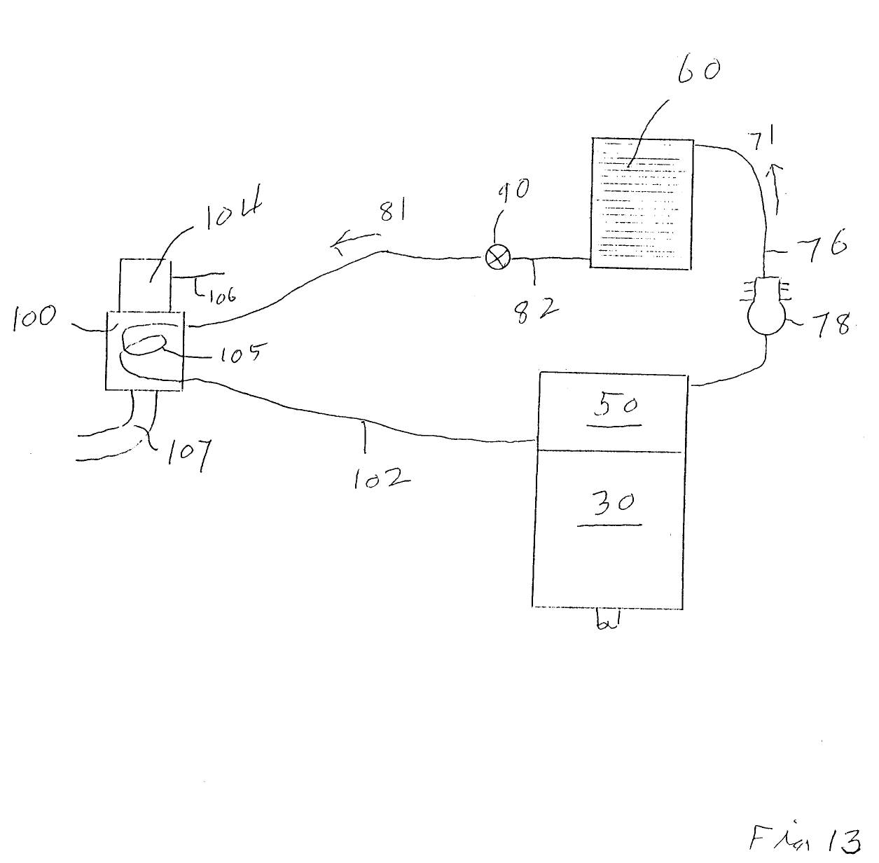

In the embodiment illustrated in FIG. 13, coolant fluid from expansion valve 90 flows first to third heat exchanger 100 and thence through passage 102 to first heat exchanger 50 and thence through first passage 76 including compressor unit 78 to second heat exchanger 60.

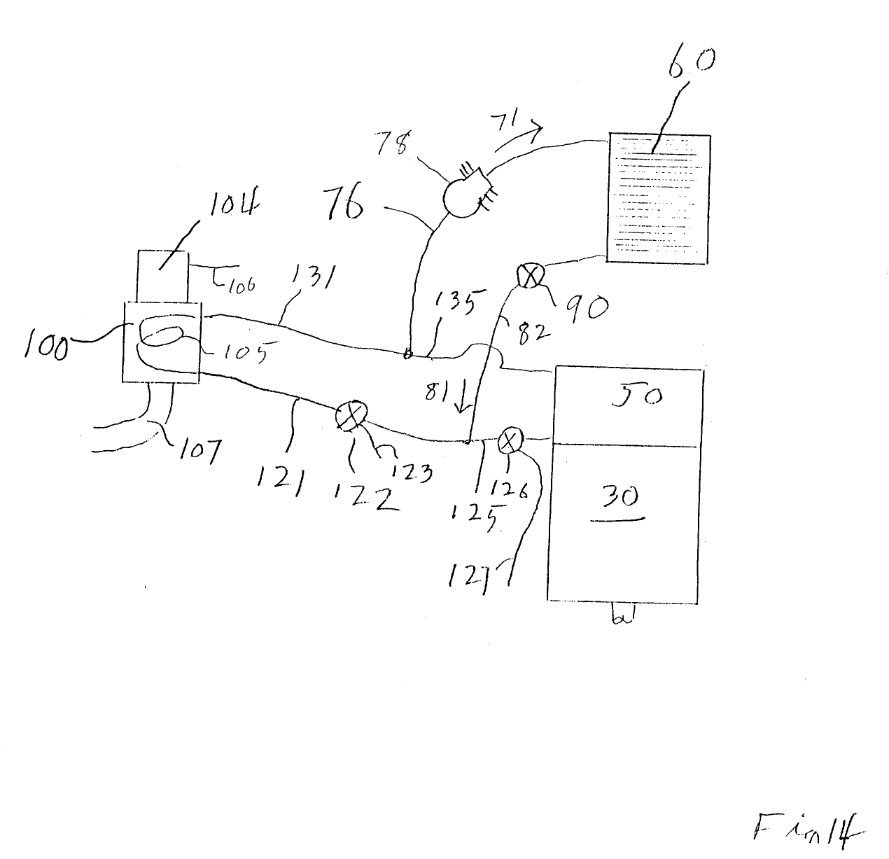

In the presently preferred embodiment illustrated in FIG. 14, first heat exchanger 50 and third heat exchanger 100 are in parallel. Coolant fluid from expansion valve 90 flows through second passage 82 and then splits, going through passage 121 having flow control valve 122 to third heat exchanger 100, and/or through passage 125 having flow control valve 126 to first heat exchanger 50. Flow control valve 122 has control connection 123 and flow control valve 126 has control connection 127. Flow returns from first heat exchanger 50 through passage 135 to first passage 76 and hence through compressor unit 78 to second heat exchanger 60. Likewise, flow returns from third heat exchanger 100 through passage 131 to first passage 76 including compressor 78 to second heat exchanger 60.

While a presently preferred and various additional alternative embodiments of the instant invention have been described in detail above in accordance the patent statutes, it should be recognized that various other modifications and adaptations of the invention may be made by those persons who are skilled in the relevant art without departing from either the spirit of the invention or the scope of the appended claims.

I claim:

1. A cooling system for an electric drive motor in an electric vehicle, said cooling system comprising:
a first heat exchanger for placement in thermal contact with such electric motor for removing heat from such electric motor, said first heat exchanger employing a coolant fluid; and
a second heat exchanger in thermal contact with said coolant fluid and with an ambient atmosphere for removing heat from said coolant fluid.

2. A motive power system for an electric vehicle having a drive train connected to at least one drive wheel, said motive power system comprising:
an electrical motor having a motive power output connection for attachment to said drive train;
a first heat exchanger having thermal connection to said electrical motor to remove heat from said electrical motor, said first heat exchanger employing a coolant fluid;
a second heat exchanger in thermal contact with said coolant fluid and with an ambient atmosphere for removing heat from said coolant fluid;
a first fluid flow passage for conveying said coolant fluid from said first heat exchanger to said second heat exchanger and a second fluid flow passage for conveying said coolant fluid from said second heat exchanger to said first heat exchanger; and
a compressor unit which includes an a/c electric motor disposed in said first fluid flow passage to compress said fluid, said second fluid flow passage having an expansion section whereby refrigeration of said motor is provided.

3. A motive power system, according to claim 2, wherein said coolant fluid has a triple point temperature below about minus 40 degrees Celsius.

4. A motive power system, according to claim 2, wherein said coolant fluid absorbs heat from said motor by at least one of evaporation and boiling.

5. A motive power system, according to claim 2, further including a fluid flow passage connecting said first heat exchanger to said second heat exchanger.

6. A motive power system, according to claim 2, further including a fluid pump disposed in at least one of said first fluid flow passage and said second fluid flow passage to circulate said fluid between said motor and said heat exchanger.

7. A motive power system, according to claim 6, wherein said first heat exchanger includes at least one coil in thermal contact with a casing of said motor.

8. A motive power system, according to claim 7, wherein said coil is a multi turn coil of tubing.

9. A motive power system, according to claim 6, wherein said first heat exchanger includes at least one coil in thermal contact with at least one stator winding of said motor.

10. A motive power system, according to claim 2, wherein at least a portion of said coolant fluid has a pressure lower than one bar absolute.

11. A motive power system, according to claim 10, wherein said coolant fluid is an alcohol.

12. A motive power system, according to claim 2, wherein said expansion section includes a capillary.

13. A motive power system, according to claim 2, wherein said expansion section includes an expansion valve having a controllable impedance to fluid flow.

14. A motive power system, according to claim 2, further including a blower disposed to move chilled air from said first heat exchanger to said motor.

15. A motive power system, according to claim 14, further including at least one duct to convey said air to said motor.

16. An electric vehicle having a motive power system comprising:
an electrical motor having a motive power connection to at least one drive wheel of said vehicle;
a first heat exchanger having thermal connection to said electrical motor to remove heat from said electrical motor, said first heat exchanger employing a coolant fluid; and a second heat exchanger in thermal contact with said coolant fluid and with an ambient atmosphere for removing heat from said coolant fluid.

17. An electric vehicle, according to claim 16, wherein said second heat exchanger is located at a greater elevation in said vehicle than said first heat exchanger whereby gravity convection causes said coolant fluid to move from said first heat exchanger to said second heat exchanger and from said second heat exchanger to said first heat exchanger.

18. An electric vehicle, according to claim 16, further including:
a third heat exchanger having thermal connection to a passenger compartment of said electric vehicle to cool such passenger compartment;
a first fluid flow passage connected to convey said coolant fluid from at least one of said first heat exchanger and said third heat exchanger to said second heat exchanger;
a second fluid flow passage connected to carry said coolant fluid from said second heat exchanger to at least one of said first heat exchanger and said second heat exchanger;
a third fluid flow passage connecting said first heat exchanger and said second heat exchanger;
a compressor unit which includes an a/c electric motor disposed in said first fluid flow passage; and
an expansion section disposed in said second fluid flow passage whereby refrigeration of such passenger compartment and said motor is provided.

19. An electric vehicle, according to claim 18, wherein said first heat exchanger and said third heat exchanger are connected in parallel and said vehicle includes at least one valve connected to control a flow of said coolant fluid through at least one of said first heat exchanger and said third exchanger.
